(19) United States
(12) Patent Application Publication
(10) Pub. No.: US 2026/0264978 A1
(43) Pub. Date: Sep. 10, 2026

(54) SAMPLER ASSEMBLY FOR A FLUID CONTAINER, CORRESPONDING FLUID CONTAINER ASSEMBLY AND ASSOCIATED METHODS

(71) Applicant: 9387-6670 QUÉBEC INC., Témiscouata-sur-le-Lac (CA)

(72) Inventor: Jean-Luc RICHARD, Saint-Louis-du-Ha! Ha! (CA)

(21) Appl. No.: 19/353,419

(22) Filed: Oct. 8, 2025

Related U.S. Application Data
(60) Provisional application No. 63/767,807, filed on Mar. 6, 2025.

(51) Int. Cl. B65D 90/56; B65D 90/66; G01N 1/10

(52) U.S. Cl. CPC B65D 90/56; B65D 90/66; G01N 1/10; B65D 2201/00; B65D 2590/245; B65D 2590/542; G01N 2001/1037

(57) ABSTRACT

The present disclosure concerns a sampler assembly for a fluid container, comprising: a container-mounting socket comprising a sampling through opening dividable into a first section opening and a second section opening; a sampling membrane received within the first section of the sampling through opening; a retaining ring received within the first section opening and comprising a probe-receiving aperture, the retaining ring retaining the sampling membrane within the sampling through opening; and a cap at least partly received within the first section of the sampling through opening and closing the sampling through opening from the outside of the fluid container, wherein the cap is in contact with the inner wall of the container-mounting socket in the first section. A fluid container comprising the sampler assembly, and methods of installing and sampling fluid from the sampler assembly are also provided.

### PRIOR APPLICATION

The present application claims priority from U.S. provisional patent application No. 63/767,807, filed on March 6, 2025, and entitled “SAMPLER ASSEMBLY FOR A FLUID CONTAINER, CORRESPONDING FLUID CONTAINER ASSEMBLY AND ASSOCIATED METHODS”, the disclosure of which is hereby incorporated by reference in its entirety.

### TECHNICAL FIELD

The technical field relates to fluid containers, and more specifically to sampler assemblies for fluid containers.

### BACKGROUND

Containers can be used to store fluids in various industrial applications. The fluid containers can remain stationary in a warehouse or factory or can be used for transportation to other locations. The fluid containers usually include at least one entry and exit point for the fluid, such that the container can be filled and emptied out when required. Operating these fluid entry and exit points can, however, cause the risks of spilling fluid, contaminating the fluid, can be manpower demanding, and can be time consuming. To sample the fluid stored inside the fluid containers, sampling apertures can be positioned on the walls of the fluid containers and accessed by users operating sampling tools. These sampling apertures are generally surrounded by various mechanical parts which can bulge out from the fluid container walls surrounding the sampling apertures. These mechanical parts surrounding the sampling apertures can also be damaged by exterior tools or machinery, especially when the fluid containers are stored in industrial environments. Moreso, these sampling apertures can include parts that must be removed to take samples from the fluid container and that must be replaced after usage frequencies or periods of time. They can also form a contamination entry to the fluid contained in the fluid container. At least for these reasons, there is a need for a sampler assembly that overcomes the above-mentioned issues.

### BRIEF SUMMARY

It is therefore an aim of the present invention to address the above-mentioned issues.

According to a general aspect, there is provided a sampler assembly for a fluid container, comprising: a container-mounting socket configured to be engaged with a sampler-receiving through-opening formed in a wall of the fluid container, the container-mounting socket comprising a sampling through opening delimited by an inner wall and dividable into a first section opening towards an outside of the fluid container when in use and a second section opening towards an inner cavity of the fluid container; a sampling membrane received within the first section of the sampling through opening; a retaining ring received within the first section of the sampling through opening and comprising a probe-receiving aperture, the retaining ring being removably mountable to the inner wall of the container-mounting socket to retain the sampling membrane within the sampling through opening; and a cap at least partly received within the first section of the sampling through opening and closing the sampling through opening from the outside of the fluid container, wherein the cap is in contact with the inner wall of the container-mounting socket in the first section.

According to another general aspect, there is provided a fluid container assembly, comprising: a fluid container defining a material-receiving cavity delimited by walls, a sampler-receiving through-opening being formed in one of the walls; and a sampler assembly according to the present disclosure received and secured within the sampler-receiving through opening.

According to yet another general aspect, there is provided a method of installing a sampler assembly to a fluid container, comprising: inserting a container-mounting socket of the sampler assembly in a sampler-receiving through-opening formed in a wall of the fluid container, the container-mounting socket comprising a sampling through opening; inserting a sampling membrane in the sampling through opening of the container-mounting socket; inserting a retaining ring in the sampling through opening of the container-mounting socket; and closing an outer end of the sampling through opening of the container-mounting socket with a cap partially received by the sampling through opening, the cap being in contact with inner walls delimiting the sampling through opening.

### BRIEF DESCRIPTION OF THE DRAWINGS

FIG. 1 is a front perspective view of an example sampler assembly.

FIG. 2 is a rear perspective view of the example sampler assembly of FIG. 1.

FIG. 3 is a left side elevation view of the example sampler assembly of FIG. 1.

FIG. 4 is a front elevation view of the example sampler assembly of FIG. 1.

FIG. 5 is a right side elevation view of the example sampler assembly of FIG. 1.

FIG. 6 is a rear elevation view of the example sampler assembly of FIG. 1.

FIG. 7 is a cross-sectional side elevation view of the example sampler assembly of FIG. 4 taken at line 7-7.

FIG. 8 is an exploded view of the example sampler assembly of FIG. 1.

FIG. 9 is a top perspective view of a fluid container assembly comprising a fluid container and an example sampler assembly received and secured within a sampler-receiving through opening of the fluid container.

FIG. 10 is a front elevation view of the fluid container assembly of FIG. 9.

FIG. 11 is a side elevation view of the fluid container assembly of FIG. 9.

FIG. 12 is a top plan view of the fluid container assembly of FIG. 9.

FIG. 13 is a bottom plan view of the fluid container assembly of FIG. 9.

FIG. 14 is a top perspective view of another fluid container assembly.

FIG. 15 is a detailed view of section A of FIG. 14 showing a portion of the fluid container assembly comprising the sampler assembly.

FIG. 16 is a cross-sectional view of the portion of the fluid container assembly of FIG. 15.

FIG. 17 is a cross-sectional exploded side view of the portion of the fluid container assembly of FIG. 15.

FIG. 18 is showing a first step of installing the sampler assembly to the fluid container.

FIG. 19 is a showing a second step of installing the sampler assembly to the fluid container.

FIG. 20 is showing a first step of sampling fluid from the sampler assembly secured to the fluid container.

FIG. 21 is showing a second step of sampling fluid from the sampler assembly secured to the fluid container.

### DETAILED DESCRIPTION

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional and are given for exemplification purposes only. Moreover, it will be appreciated that positional descriptions such as "above", "below", "forward", "rearward", "left", "right" and the like should, unless otherwise indicated, be taken in the context of the figures only and should not be considered limiting. Moreover, the figures are meant to be illustrative of certain characteristics of the barrel and are not necessarily to scale.

To provide a more concise description, some of the quantitative expressions given herein may be qualified with the term "about". It is understood that whether the term "about" is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the following description, an embodiment is an example or implementation. The various appearances of "one embodiment", "an embodiment" or "some embodiments" do not necessarily all refer to the same embodiments. Although various features may be described in the context of a single embodiment, the features may also be provided separately or in any suitable combination. Conversely, although the invention may be described herein in the context of separate embodiments for clarity, it may also be implemented in a single embodiment. Reference in the specification to "some embodiments", "an embodiment", "one embodiment" or "other embodiments" means that a particular feature, structure, or characteristic described in connection with the embodiments is included in at least some embodiments, but not necessarily all embodiments.

It is to be understood that the phraseology and terminology employed herein is not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure.

Furthermore, it is to be understood that the disclosure can be carried out or practiced in various ways and that the disclosure can be implemented in embodiments other than the ones outlined in the description above. It is to be understood that the terms "including", "comprising", and grammatical variants thereof do not preclude the addition of one or more components, features, steps, or integers or groups thereof and that the terms are to be construed as specifying components, features, steps or integers. If the specification or claims refer to "an additional" element, that does not preclude there being more than one of the additional element. It is to be understood that where the claims or specification refer to "a" or "an" element, such reference is not be construed that there is only one of that element. It is to be understood that where the specification states that a component, feature, structure, or characteristic "may", "might", "can" or "could" be included, that particular component, feature, structure, or characteristic is not required to be included.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined. It will be appreciated that the methods described herein may be performed in the described order, or in any suitable order.

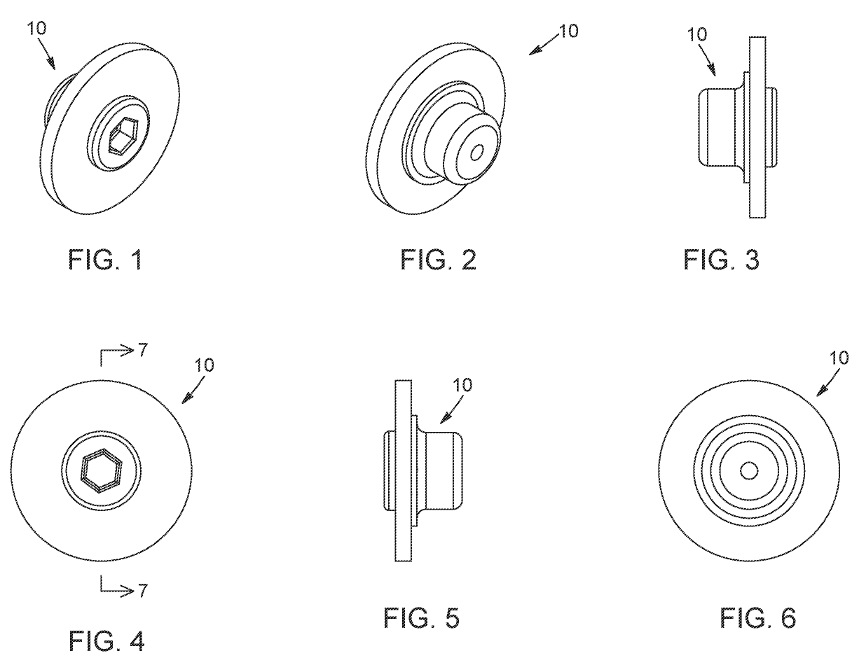

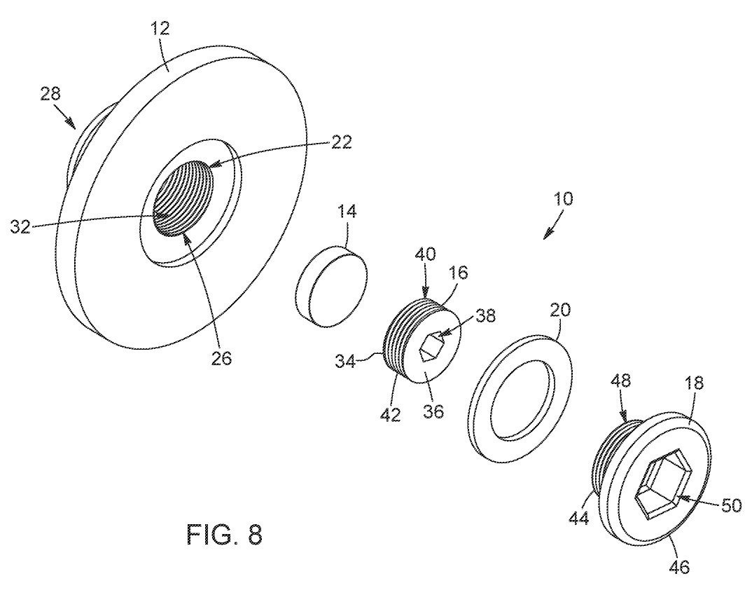

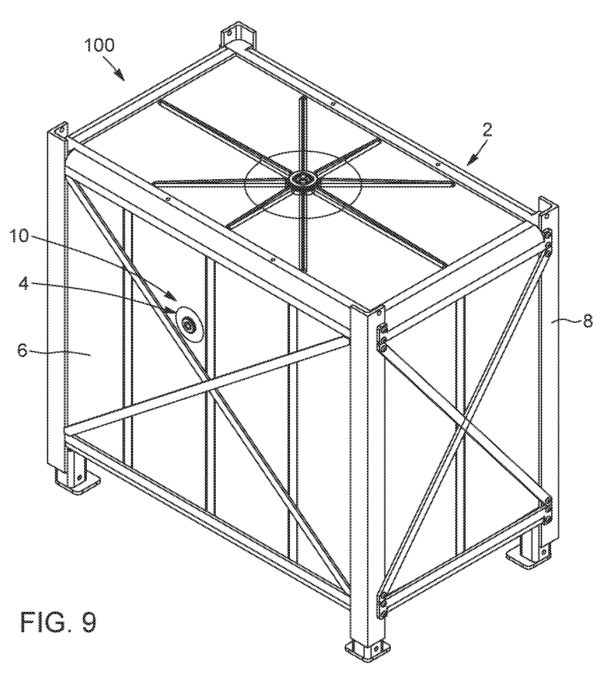

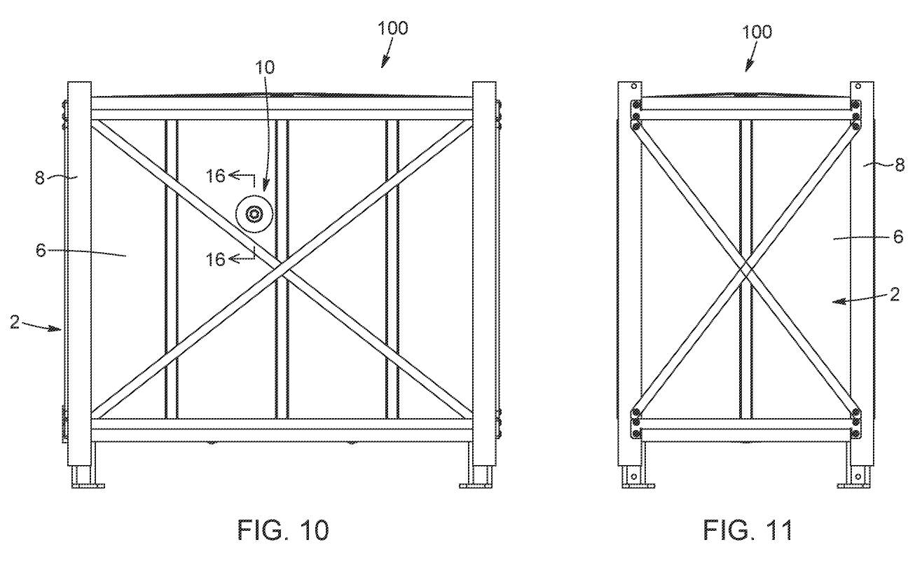

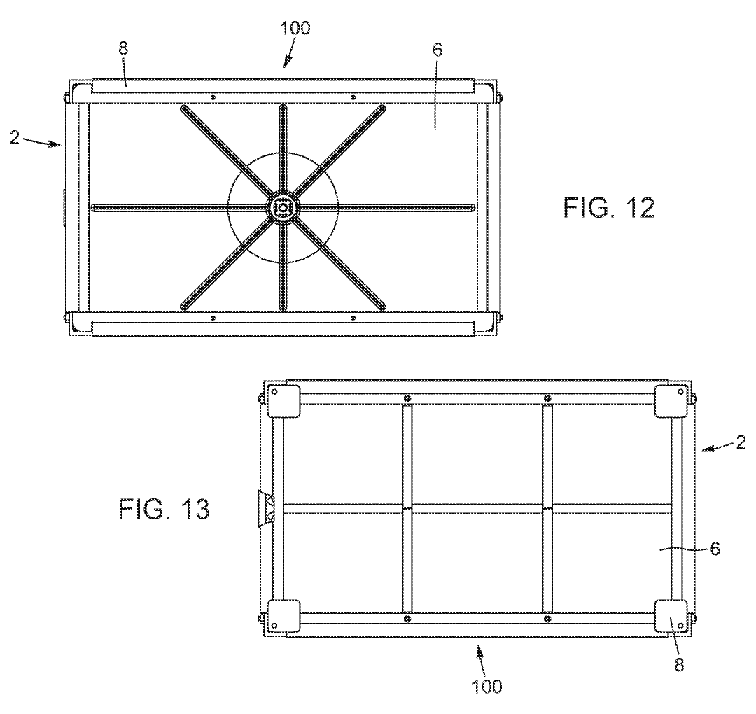

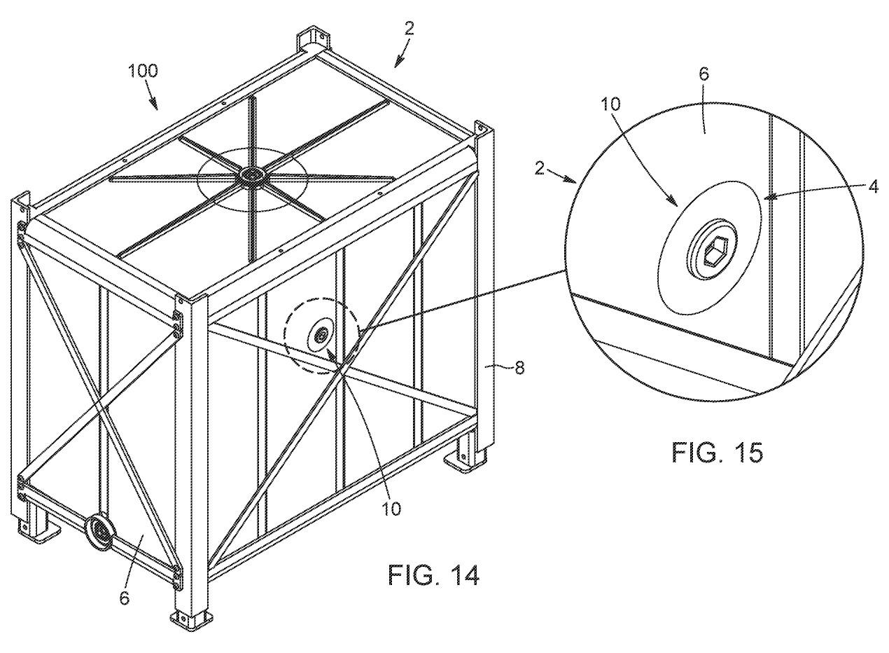

Referring now to the drawings, and more particularly to FIGS. 1 to 8, an exemplary sampler assembly 10 for a fluid container 2 is shown. The sampler assembly 10 is configured to be received and secured to the fluid container 2, as shown in FIGS. 9 to 14, such that fluid can be sampled therefrom. Referring specifically to FIG. 8, the sampler assembly 10 includes a container-mounting socket 12 configured to be engaged with a sampler-receiving through-opening 4 formed in a wall 6 of the fluid container 2. The container-mounting socket 12 can have a generally cylindrical shape, however it can also have any other outer shape that corresponds to the shape of the sampler-receiving through-opening 4 of the fluid container 2. The sampler assembly 10 also includes a sampling membrane 14, a retaining ring 16 and a cap 18. The sampler assembly 10 can further include one or more sealing members 20.

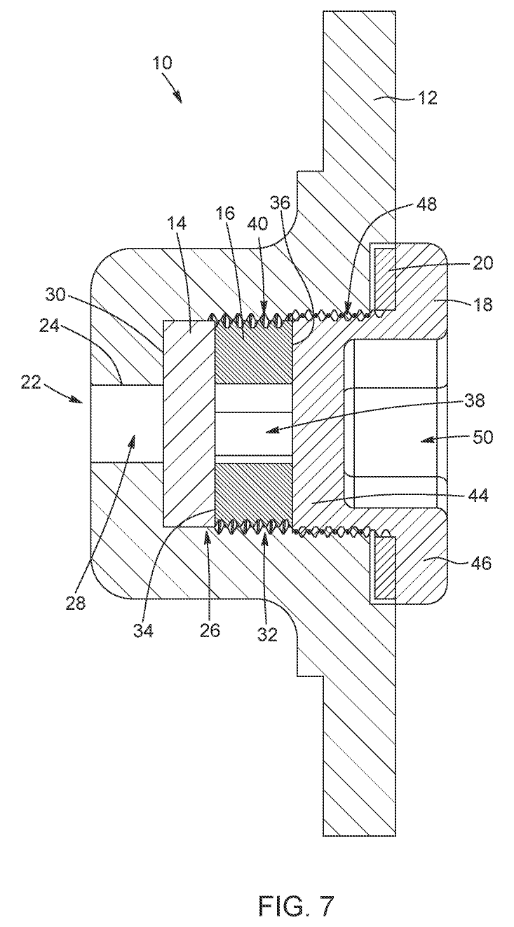

Referring to FIGS. 7 and 8, the container-mounting socket 12 includes a sampling through opening 22 delimited by an inner wall 24 and dividable into a first section 26 and a second section 28. When the sampler assembly 10 is in use, i.e., is received within the sampler-receiving through-opening 4 of the fluid container and secured to a wall of the fluid container 2, the first section 26 opens toward an outside of the fluid container 2 and the second section 28 opens toward an inner cavity (or fluid-receiving cavity) of the fluid container 2. The first and second sections 26, 28 of the sampling through opening 22 can have different sizes and shapes of cross-section. Additionally, the sampling through opening 22 can include more than two sections. In the example shown, the first and second sections 26, 28 are cylinder shaped (i.e., have a disk-shaped cross-section) and the second section 28 has a smaller cross-section than the first section 26. A shoulder 30 is thus defined at a junction of the first and second sections 26, 28 that can receive in abutment parts of the sampler assembly 10 inserted within the first section 26 of the sampling through opening 22. The inner wall 24 of the sampling through opening 22 can include fastening members 32 for fastening parts of the sampler assembly 10 received within the sampling through opening 22. For example, the inner wall 24 can include threads 32 configured to engage with corresponding threads of other pieces of the sampler assembly 10.

The sampler assembly 10 further includes the sampling membrane 14 that is removably received within the sampling through opening 22 of the container-mounting socket 12. The sampling membrane 14 is engaged through the first section 26 and abuts against the shoulder 30 defined by the junction of the first and second sections 26, 28 so as to close the second section 28 of the sampling through opening. The sampling membrane 14 is dimensioned such that when it is engaged within the first section 26 of the sampling through opening 22, it fully covers the second section 28 at the junction between the two sections 26, 28 thereof. It will be appreciated that the sampling membrane 14 is configured to prevent fluid from flowing out of the second section opening 28 towards the first second 26 of the sampling through opening 22 and then outside of the fluid container 2. The sampling membrane 14 can therefore be impermeable (or liquid-proof) to at least some types of fluids and have a permeability that prevents fluids, or at least fluids that can be housed within the fluid container 2, to flow therethrough. Because the sampling membrane 14 can be punctured by a probe, or sampling tool, when sampling the fluid housed within the fluid container 2, the sampling membrane 14 can be configured to remain at least substantially impermeable (or liquid-proof) after puncture from the probe. The sampling membrane 14 can be made for instance and without being limitative at least partially of at least one of silicone, rubber, synthetic cork and/or composite material.

The sampler assembly 10 further includes the retaining ring 16 received within the sampling through opening 22 of the container-mounting socket 12. The retaining ring 16 includes a membrane-facing end 34 and an opposed cap-facing end 36. In the embodiment shown, the retaining ring 16 is received within the first section 26 of the sampling through opening 22 and is configured to retain the sampling membrane 16 within the sampling through opening 22. When installed within the first section 26, the retaining ring 16 prevents displacement of the sampling membrane 14, notably from the shoulder 30 at the junction between the first and second sections 26, 28, by having its membrane-facing end 34 abutting against the surface of the sampling membrane 14 facing outside of the fluid container 2 (i.e., the outer surface of the sampling membrane 14). The retaining ring 16 is for instance cylindrical in shape and includes a probe-receiving aperture 38 spanning from its membrane-facing end 34 to its cap-facing end 36. The probe-receiving aperture 38 is positioned such that the probe collecting the fluid sample from the fluid container 2 passing through can also pass through the second section 28 of the sampling through opening 22 of the container-mounting socket 12. In the example shown, the probe-receiving aperture 38 is concentric with the second section 28 of the sampling through opening 22 of the container-mounting socket 12, such that a straight portion of the probe can pass through the probe-receiving aperture 38 and the second section 28 of the sampling through opening 22. The retaining ring 16 is securable to the inner wall 24 of the container-mounting socket 12 with a fastening mechanism 40. In the example shown, the retaining ring 16 includes threads 40 formed on an outer peripheral wall 42 thereof that can engage with the threads 32 of the inner wall 24 of the container-mounting socket 12.

The sampler assembly 10 further includes the cap 18 at least partially received within the first section 26 of the sampling through opening 22 of the container-mounting socket 12. The cap 18 is configured to close the sampling through opening 22 from the outside of the fluid container 10 when at least partially engaged with the container-mounting socket 12 (for instance, at least partially received by the first section 26 of the container-mounting socket 12). The cap 18 includes a plug section 44 insertable within the sampling through opening 22 (for instance in the first section 26 thereof) and a cover section 46 that is configured to remain at least partially outside of the sampling through opening 22. The cover section 46 can have a cross-section larger than or equal to the cross-section of the plug section 44. The cross-section of the plug section 44 can be larger than or equal to the cross-section of the cap-facing end 36 of the retaining ring 16. The cover section 46 can apply pressure on the surface 13 of the container-mounting socket 12 and/or the sealing member 20 around the outside end of the sampling through opening 22. The plug section 44 is cylindrical in shape and is securable to the inner wall 24 of the container-mounting socket 12 with a fastening mechanism 48. The plug section 44 can apply pressure on the cap-facing end surface 36 of the retaining ring 16, for instance on an entirety of the cap-facing end surface. In the example shown, the plug section 44 includes threads 48 formed on an outer peripheral wall that can engage with the threads 32 of the inner wall 24 of the container-mounting socket 12. The plug section 44 can abut against the cap-facing end 36 of the retaining ring 16. In some implementations, the cap 18 can be fully housed within the sampling through opening 22 (for instance fully housed within the first section 26 of the sampling through opening 22).

The cap 18 can also include a tool-coupling portion or tool-coupling member 50 formed on or mounted to an outer face 19 of the cap 18. The tool-coupling portion 50 is configured to engage with a tool to secure and unsecure the cap 18 to the container-mounting socket 12. In the example shown, the tool-coupling portion 50 is a tool-engaging aperture 50 configured to receive and engage with the tool. In other examples, the cover section 46 of the cap 18 can form at least partially the tool-coupling member 50.

The sampler assembly 10 can also include the one or more sealing members 20. The sealing member 20 can be installed between any of the above-detailed parts of the sampler assembly 10 to prevent or limit fluid flow therebetween. In the example shown, the sealing member 20 is a sealing ring 20, i.e., an O-ring, installed between the outer surface of the container-mounting socket 12 bordering an outer end of the first section opening 26 and a socket-facing surface of the cap’s 18 cover section 46. The sealing member 20 can be made of the same material or of a different material as the sampling membrane 14. For instance, the sealing member is at least partially made of silicone and/or rubber. Understandably, the sealing member 20 can have a permeability that prevents or limits the flow of fluids (i.e., might be liquid-proof). The sealing member 20 can also limit friction and contact damage between two parts of the sampler assembly 10.

It will be appreciated that at least one or each of the sampling membrane 14, the retaining ring 16, the cap 18, and the sealing member 20 can be removably installed to the container-mounting socket 12. At least one of the sampling membrane 14, the retaining ring 16, and the cap 18 can be removably received and removably secured to the inner wall 24 of the container-mounting socket 12. The container-mounting socket 12 can be removably or permanently secured to the fluid container 2. In an example, the container-mounting socket 12 can be secured to the fluid container 2, for instance welded thereto (for instance spin-welded thereto) and/or punched thereto, when the container is at least partially made of steel or aluminum.

Referring now to FIGS. 9 to 15, a fluid container assembly 100 is shown that includes the sampler assembly 10 received by and secured to the fluid container 2. The fluid container 2 defines a material-receiving cavity 102 delimited by walls 6. In the examples shown, the fluid container 2 includes six walls 6 and multiple frame elements 8 supporting the walls 6. In other examples, the fluid container 2 can have any number of walls 6 and frame elements 8. The fluid container 2 further includes a sampler-receiving through-opening 4 formed in one of the walls 6. The sampler assembly 10 is received and secured within the sampler-receiving through opening 4. The sampler-receiving through-opening 4 can be in any of the walls 6 of the fluid container 2. The sampler-receiving through-opening 4 provides access from the outside of the fluid container 2 to the material-receiving cavity 102, or inner cavity, of the fluid container 2. The material-receiving cavity 102 of the fluid container 2 is configured to house fluids therein.

Understandably, there can be more than one sampler-receiving through opening 4 on the fluid container 2. Each of the sampler-receiving through-openings 4 can receive its own sampler assembly 10. Alternatively, one of the sampler-receiving through-openings 4 can receive its sampler assembly 10 and the other sampler-receiving through-openings 4 can be plugged by other permanent or temporary means. With multiple sample-receiving through-openings 4, the openings can provide access to the same material-receiving cavity 102 or to different material-receiving cavities 102 if there are more than one in the fluid container 2.

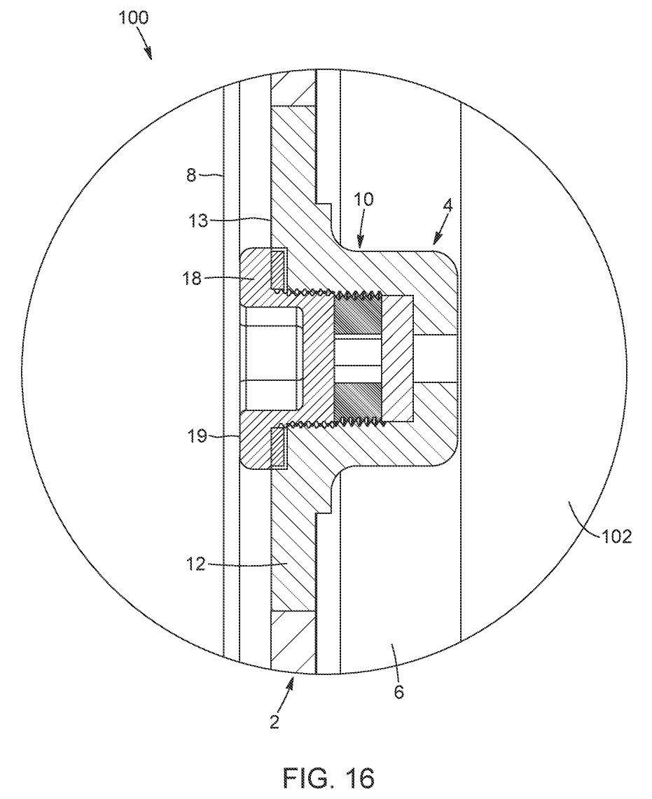

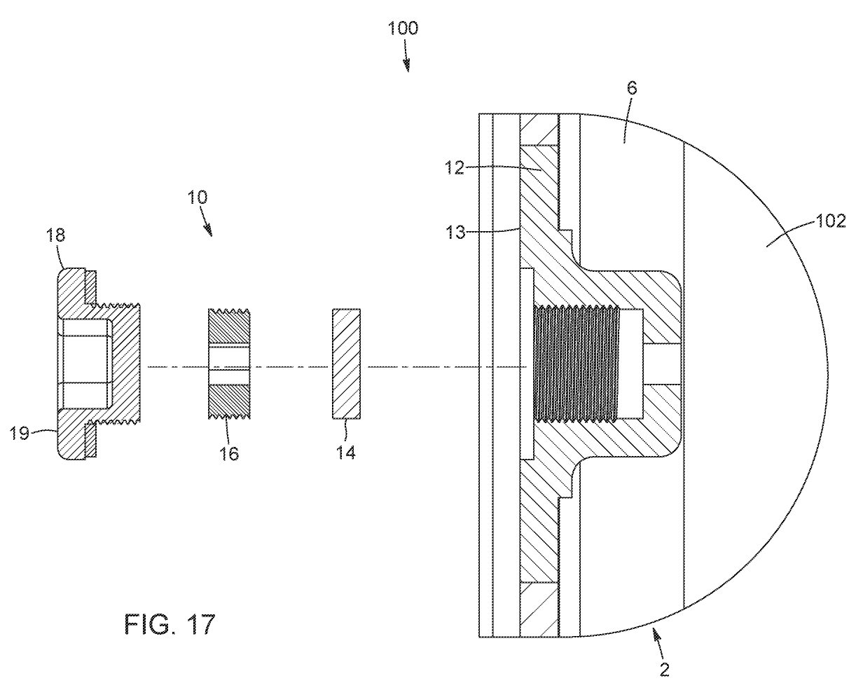

Referring additionally to FIGS. 16 and 17, the sampler assembly 10 received in the sample-receiving through-opening 4 can minimally project outside of the fluid container 2. In a first example, the cap 18 of the sampler assembly 10 can project outside of the fluid container’s wall 6 such that its outer surface 19 is flush or inwardly offset with respect to the frame elements 8. In a second example, the outer surface 13 of the container-mounting socket 12 can be substantially flush or inwardly offset with the outer surface 7 of the fluid container’s wall 6. With either or both of these two features, it can be appreciated that the chances of objects encroaching and damaging the sampler assembly 10 can be limited.

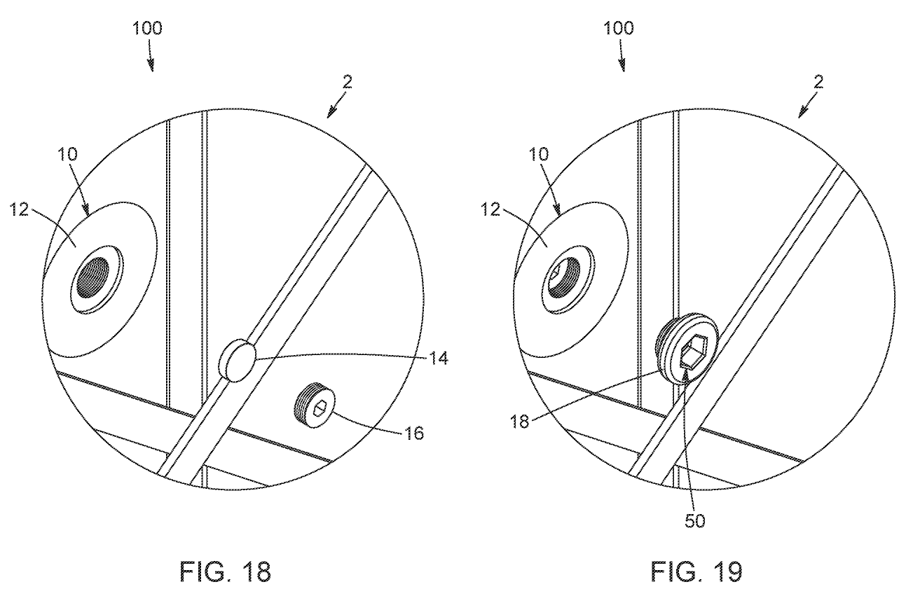

Referring to FIGS. 18 and 19, a method of installing removable parts of the sampler assembly 10 to the container-mounting socket 12 is provided. The removable parts of the sampler assembly 10 can include the sampling membrane 14, the retaining ring 16 and the cap 18. The removable parts of the sampler assembly 10 are installed to the container-mounting socket 12 to block the fluid from flowing out from the sampler-receiving through-opening 4 and removed from the container-mounting socket 12 to allow sampling of the fluid from the material-receiving cavity 102 in the fluid container 2. It will be appreciated that the container-mounting socket 12 can remain secured within the sampler-receiving through-opening 4 of the fluid container 2 during installation and uninstallation of the other parts of the sampler assembly 10. Referring specifically to FIG. 18, the sampling membrane 14 is first inserted within the sampling through opening 22. The sampling membrane 14 can be inserted within the container-mounting socket 12 until it abuts against the shoulder 30 at the junction between the first section 26 and the second section 28 of the sampling through opening 22. The retaining ring 16 is then inserted within the sampling through opening 22 until it abuts against the sampling membrane 14. Referring to FIG. 19, the cap 18 is inserted within the sampling through opening 22 until it either abuts against the retaining ring 16, it cannot be inserted further in the sampling through opening 22, or both. The retaining ring 16 and the cap 18 can be inserted by fastening the threads 40, 48 on their respective outer surface with the threads 32 of the inner wall 24 of the container-mounting socket 12. The cap 18 can also be secured to the container-mounting socket 12 by using the tool engaging with the tool-coupling member 50 of the cap 18. It can be readily understood that a method of uninstalling the removable parts of the sampler assembly 10 can also be performed by performing the above-described steps in reserved order. For example, the method of uninstalling the removable parts can be used to remove and replace any of the removable parts of the sampler assembly 10, such as the sampling membrane 14.

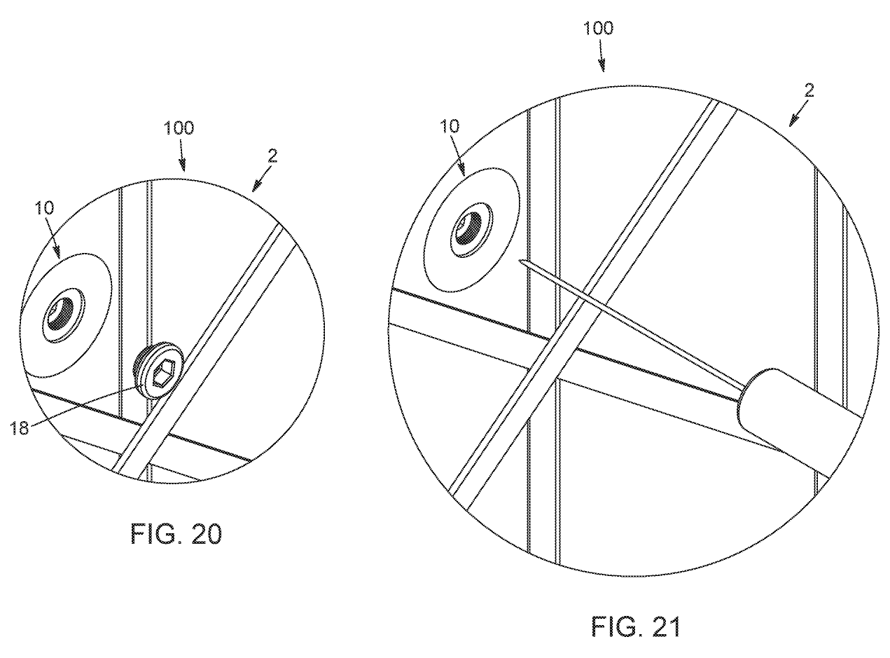

Referring now to FIGS. 20 and 21, a method of sampling fluid from the fluid container assembly 100 is provided. Before performing the first step of the sampling method, the sampler assembly 10 is installed on the fluid container 2, i.e., the sampling membrane 14, the retaining ring 16, and the cap 18 are received and secured to the container-mounting socket 12. The first step of the sampling method includes removing the cap 18 from the container-mounting socket 12 such that the first section 26 of the sampling through opening 22 is opened to the outside of the fluid container 2. A tool that engages with the tool-coupling member or tool-coupling portion 50 of the cap 18 can be used to remove the cap 18. The second step of the sampling method includes inserting a sampling tool through the probe-receiving aperture 38 of the retaining ring 16, through the sampling membrane 14, and through the second section 28 of the sampling through opening 22 of the container-mounting socket 12 to collect fluid from the fluid container 2. Once the sample is collected, the sampling tool can be removed from the fluid container assembly 100 and the cap 18 can be installed on the sampler assembly 10 to prevent fluid from leaking out of the fluid container 2.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited by the scope of the appended claims.

1. A sampler assembly for a fluid container, comprising:
a container-mounting socket configured to be engaged with a sampler-receiving through-opening formed in a wall of the fluid container, the container-mounting socket comprising a sampling through opening delimited by an inner wall and dividable into a first section opening towards an outside of the fluid container when in use and a second section opening towards an inner cavity of the fluid container when in use;
a sampling membrane received within the first section of the sampling through opening;
a retaining ring received within the first section of the sampling through opening and comprising a probe-receiving aperture, the retaining ring being removably mounted to the inner wall of the container-mounting socket to retain the sampling membrane within the sampling through opening; and
a cap at least partly received within the first section of the sampling through opening and closing the sampling through opening from the outside of the fluid container,
wherein at least a portion of the cap is in contact with the inner wall of the container-mounting socket in the first section.

2. The sampler assembly of claim 1, the second section having a smaller cross-section than the first section so as to define a shoulder at a junction of the first and second sections, wherein the sampling membrane abuts against the shoulder.

3. The sampler assembly of claim 1, further comprising a sealing ring interposed between an outer surface of the container-mounting socket bordering an outer end of the first section and a socket-facing surface of the cap.

4. The sampler assembly of claim 1, wherein at least one of the sampling membrane, the retaining ring and the cap is removably mounted to the inner wall of the container-mounting socket.

5. The sampler assembly of claim 1, wherein the inner wall delimiting the first section of the sampling through opening comprises threads configured to engage with corresponding threads formed on an outer peripheral wall of at least one of the retaining ring and the cap.

6. The sampler assembly of claim 1, wherein the cap comprises a tool-coupling portion formed on or mounted to an outer face thereof and configured to engage with a tool to at least one of secure and unsecure the cap to the container-mounting socket.

7. The sampler assembly of claim 6, wherein the tool-coupling portion comprises a tool-engaging aperture configured to receive and engage with the tool.

8. The sampler assembly of claim 1, wherein the sampling membrane is at least partially made of at least one of silicone, rubber, synthetic cork and composite material.

9. The sampler assembly of claim 1, wherein the sampling membrane is liquid-proof and remains at least substantially liquid-proof after puncture from a sampling tool.

10. The sampler assembly of claim 1, wherein the container-mounting socket is secured to the fluid container via welding or punching.

11. The sampler assembly of claim 1, wherein the cap comprises an inner portion securable to the inner wall delimiting the first section of the sampling through opening, an outer cross-section of the inner portion of the cap being greater than or equal to an outer cross-section of a cap-facing end of the retaining ring.

12. The sampler assembly of claim 1, wherein at least one of the sampling membrane and the retaining ring is in contact with the inner wall of the container-mounting socket in the first section.

13. The sampler assembly of claim 1, wherein the cap is shaped and dimensioned to apply pressure on an entire cap-facing end surface of the retainer ring.

14. A fluid container assembly, comprising:
a fluid container defining a material-receiving cavity delimited by walls, a sampler-receiving through-opening being formed in one of the walls; and
a sampler assembly according to claim 1 received and secured within the sampler-receiving through opening.

15. The fluid container assembly of claim 14, further comprising frame elements supporting the walls.

16. The fluid container assembly of claim 15, wherein an outer surface of the sampler assembly is flush or inwardly offset with respect to the frame elements.

17. The fluid container assembly of claim 14, wherein an outer surface of the sampler assembly is flush or inwardly offset with respect to an outer surface of a portion of the wall surrounding the sampler-receiving through-opening.

18. A method of installing a sampler assembly to a fluid container, the method comprising:
inserting a container-mounting socket of the sampler assembly in a sampler-receiving through-opening formed in a wall of the fluid container, the container-mounting socket comprising a sampling through opening;
inserting a sampling membrane in the sampling through opening of the container-mounting socket;
inserting a retaining ring in the sampling through opening of the container-mounting socket; and
closing an outer end of the sampling through opening of the container-mounting socket with a cap partially received by the sampling through opening, the cap being in contact with an inner wall at least partially delimiting the sampling through opening.

19. The method of claim 18, further comprising providing a sealing member surrounding at least partially the sampling through opening of the container-mounting socket, the sealing member being sandwiched between the container-mounting socket and the cap.

20. A method of sampling fluid from a fluid container comprising a sampler assembly, comprising:
removing a cap from the sampler assembly closing a sampling through opening providing access to a material-receiving cavity defined by the fluid container;
inserting a sampling tool through a sampling membrane arranged in the sampling through opening to retrieve a fluid contained in the material-receiving cavity;
removing the sampling tool from the sampling through opening; and
closing the sampling through opening with the cap partially received within the sampling through opening, the cap being in contact with an inner wall delimiting the sampling through opening.
